(19) United States
(12) Patent Application Publication
(10) Pub. No.: US 2015/0113451 A1
(43) Pub. Date: Apr. 23, 2015

(54) CREATION OF WIDGETS BASED ON A CURRENT DATA CONTEXT

(71) Applicants: Steve Kopp, Levallois-Perret (FR); Geraldine Bous, Sophia-Antipolis Cedex (FR); Gerald Kleser, Sophia-Antipolis Cedex (FR); Valdrin Koshi, Palo Alto, CA (US); Kevin Le Fur, Levallois-Perret (FR); Alexis Madinier, Levallois-Perret (FR); Cathie Marache-Francisco, Levallois-Perret (FR); Emesto Mudu, Palo Alto, CA (US); Magali Seguran, Sophia-Antipolis Cedex (FR); Aline Senart, Sophia-Antipolis Cedex (FR)

(72) Inventors: Steve Kopp, Levallois-Perret (FR); Geraldine Bous, Sophia-Antipolis Cedex (FR); Gerald Kleser, Sophia-Antipolis Cedex (FR); Valdrin Koshi, Palo Alto, CA (US); Kevin Le Fur, Levallois-Perret (FR); Alexis Madinier, Levallois-Perret (FR); Cathie Marache-Francisco, Levallois-Perret (FR); Emesto Mudu, Palo Alto, CA (US); Magali Seguran, Sophia-Antipolis Cedex (FR); Aline Senart, Sophia-Antipolis Cedex (FR)

(21) Appl. No.: 14/061,708

(22) Filed: Oct. 23, 2013

(51) Int. Cl. G06F 3/0484

(52) U.S. Cl. CPC G06F 3/0484
USPC 715/764

(57) ABSTRACT

Creation of a widget for presenting a key indicator is initiated based on a selection over first displayed data. The selection is made over a portion of the first displayed data. A current data context for the first displayed data and the made selection is determined. Based on the current data context, a list of widget types available for creation of a widget for the key indicator is suggested. For the elements from the list of widget types, an advice is built to include a list of widget descriptors. An interaction is made to select a widget descriptor from the advice. According to the selected widget descriptor, a widget is created that embeds a query that extracts a portion of the current data context in order to present relevant widget data for the key indicator within the widget.

### BACKGROUND

Enterprises and end users can gain value by analyzing data generated through transactional systems. Exploring and understanding information may be a time consuming activity due to the high volume and complexity of the data. A widget is a type of software application that includes portable code to be integrated with different software platforms. Widgets may be applied in different types of contexts. A web widget is a small graphical user interface (GUI) element with limited functionality that can be embedded into a web page and monitored by an end user. The web widget may occupy a portion of a web page and present fetched information from other websites for example. Widgets may be utilized to highlight different characteristics over explored data in a condensed manner. Widgets display information and may include buttons, dialog boxes, progress indicators, menu bars, forms, etc. Through widgets users are allowed to turn content into dynamic web applications that may be shared on websites, blogs, social media sites, etc., where the code can be installed.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an exemplary environment for creating widgets for monitoring key indicators based on data selection during data navigation, according to one embodiment.

FIG. 2 is a block diagram illustrating a screen used for defining and generating widgets based on a current data context, according to one embodiment.

FIG. 3 is a block diagram illustrating exemplary widgets of different types, according to one embodiment.

FIG. 4 is a block diagram illustrating an exemplary alert created during data navigation and selection, according to one embodiment.

FIG. 5 is a flow diagram illustrating a process for generating widgets based on a current data context, according to one embodiment.

FIG. 6 is a block diagram illustrating a landscape for generating a widget for monitoring a key indicator from an environment, according to one embodiment.

FIG. 7 is a flow diagram illustrating a process for creating widgets and monitoring key indicators from a portal application, according to one embodiment.

FIG. 8A is a block diagram illustrating a system for creating widgets based on a current data context, according to one embodiment.

FIG. 8B is a block diagram illustrating a system for creating widgets based on a current data context, according to one embodiment.

FIG. 9 is a block diagram illustrating a sequence diagram for building an advice, recommending a set of widget descriptors for creating of a widget, according to one embodiment.

FIG. 10 is a block diagram illustrating a sequence diagram for creating a widget based on a selection from a provided advice with a recommended list of widget descriptors, according to one embodiment.

FIG. 11 is a block diagram illustrating an embodiment of a computing environment in which the techniques described for creating widgets based on a current data context can be implemented.

### DETAILED DESCRIPTION

Embodiments of techniques for creation of widgets based on a current data context are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in suitable manner in one or more embodiments.

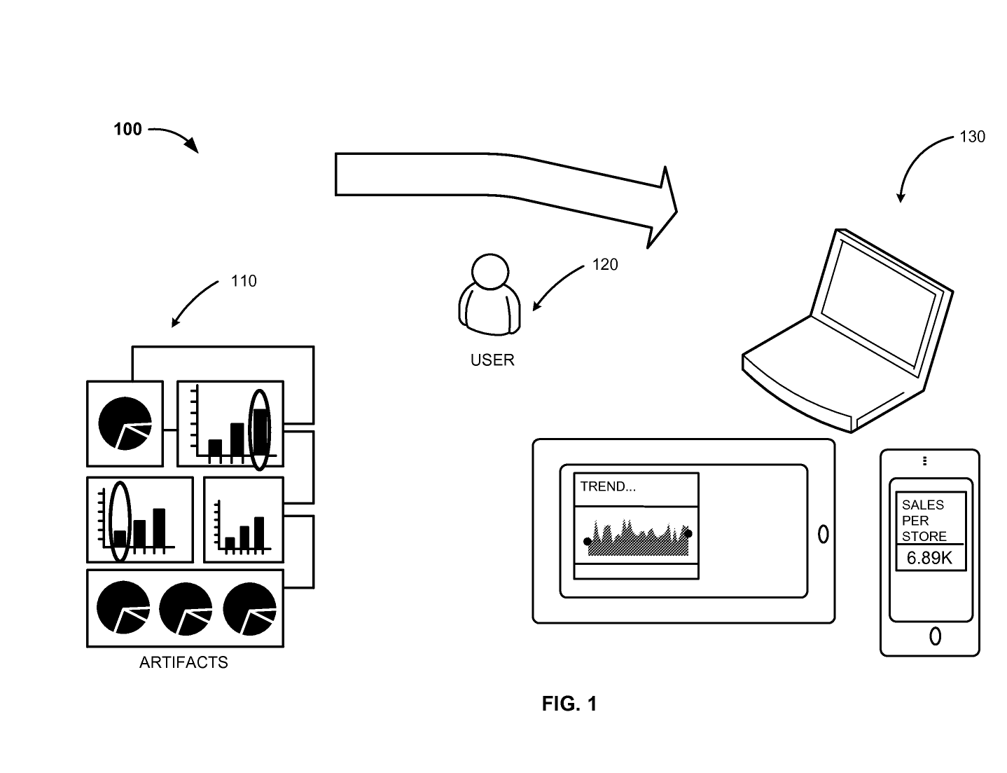

FIG. 1 is a block diagram illustrating an exemplary environment 100 for creating widgets for monitoring key indicators based on data selection during data navigation. Widgets are small visualizations that may point out information of particular interest to a user. Widgets may be created out of existing artifacts 110 such as bar charts, pie charts, etc., describing information of particular relevance to user 120. In one embodiment, widgets may be created based on user selection of sections from a chart that correspond to information regarding a key indicator of user's interest. For example, widgets may be created by the user 120 in self-service workflows, without assistance from an IT representative. The user 120 may be an analyst or a regular business user. Based on artifacts 110, the user 120 may create widgets for presenting them in a graphical user interface (GUI) on a device from a set of devices 130. The set of devices 130 may include a desktop computer, a laptop, a tablet or other handheld device, etc. The artifacts 110 may be aggregated data also presented in the GUI of the device in form of a chart, a table, or other graphical representation that provides insight into a specific business domain. Based on the presented artifacts 110 and a user interaction with the GUI, widgets may be created. Widgets may be used to highlight or to monitor business information about key indicators. Widgets may be displayed in dashboards and analytics. For monitoring purposes, the user 120 may use a dedicated space, such as a portal page, dashboard, etc., where specific widgets of interest from multiple sources may be collected. Such a space may be consumed from one or more devices from the set of devices 130.

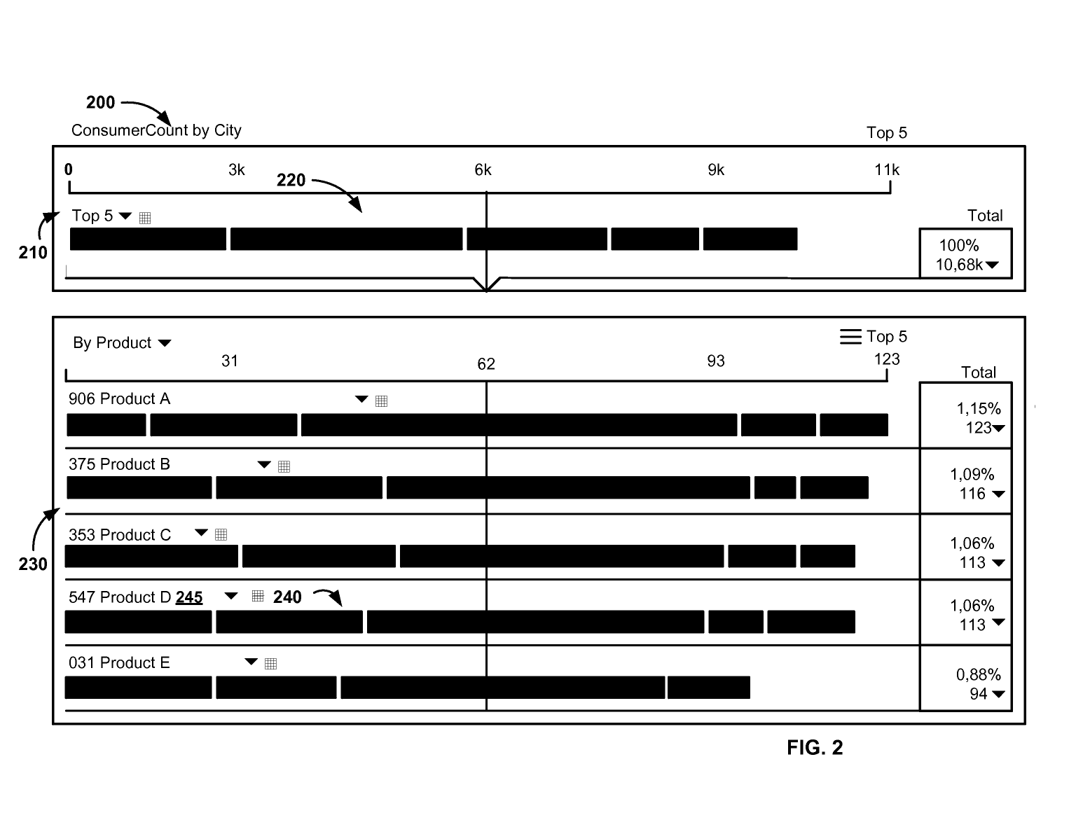

FIG. 2 is a block diagram illustrating a screen 200 used for defining and generating widgets based on a current data context, according to one embodiment. On a GUI, a user may display summarized information about a retail shop that operates in a number of cities and sells a number of products. The summarized information may be based on raw data stored for the retail shop for different purposes and by different systems. On the screen 200, there is a section 210 that displays the number of consumers divided between the top five cities. The raw data used for generating this aggregated data on section 210 may further include additional data related to the retail shop. The user, e.g. a business analyst, may be interested in monitoring which cities have the highest number of consumers. Therefore, a widget for monitoring the ranking of the top five cities may be generated based on the display data in the section 210. With such a widget, the business analysis may not further need to navigate to present on the GUI the aggregated data as in the section 210. The initiation for creation of the widget may be started, for example, by selecting the section 210 with a mouse, keyboard, or other device. Such a widget may be stored on a separate page, where further widgets are stored and used for monitoring. The user may be further interested in the number of consumers for a particular city. For example, the city with the second ranking in the top five cities. Block 220 corresponds to a section that presents the number of consumers for the second-ranked city from the top five cities. The user may initiate creation of a widget of a specific type for monitoring the number of consumers for the second-ranked city by selecting the block 220 and defining the type of the widget he/she wants to use.

In one embodiment, a widget may be created by a selection of a portion of data presented in section 230, which is also part of the screen 200. For example, a widget may be created to monitor the number of consumers for the second-ranked city for a product “Product D” 245 (fourth row in the section 230). Block 240 (corresponding to the second-ranked city) may be selected to initiate the creation of the widget for monitoring a trend of the number of consumers. The widget may be configured to present a trend line for monitoring a time period, which may be the current year, based on the number of consumers per quarter. For generating such a widget, a data context for the widget may be determined that contains the data from the selection of the block 240, and is further extended with additional data about the time context and the type of selection that is made by the user. In addition, the data may not only be extended with a time context, but also with geographical context, or other filtering context that may be applied on the data. The determined data context is used for generating the widget and includes data that is not presented on the screen 200, but is relevant and is required for generating the above defined widget. For generating the widget, data from the raw data used for generating the screen 200 may be extracted. The displayed data in the created widget may be determined based on a defined key indicator that is monitored or highlighted, the defined data context, and the type of the widget that is selected.

A number of widget types may be created by a user for monitoring a particular key indicator. In one embodiment, aggregated data over some raw data may be presented to the user on a GUI. Data may be presented as shown in FIG. 2. The aggregated data may provide details about the number of consumers of products in different cities. The data may be filtered only to the top 5 cities or top 10 cities with the highest rate of number of consumers. The presented aggregated data in the GUI may be filtered, sorted, divided according to some logic, etc. Based on the presented data in the GUI, a user may select a particular area of interest for defining a widget. The user may be a manager of a retail shop who is interested in the ranking of the cities. Depending on what is aimed at—highlighting or monitoring, widgets may be static and monitorable, respectively. In one embodiment, monitorable widgets may require that the underlying dataset contains a time dimension, which means that the dataset is a dynamic dataset. In another embodiment, widgets may be used only to highlight a defined key indicator based on historic data, which is static.

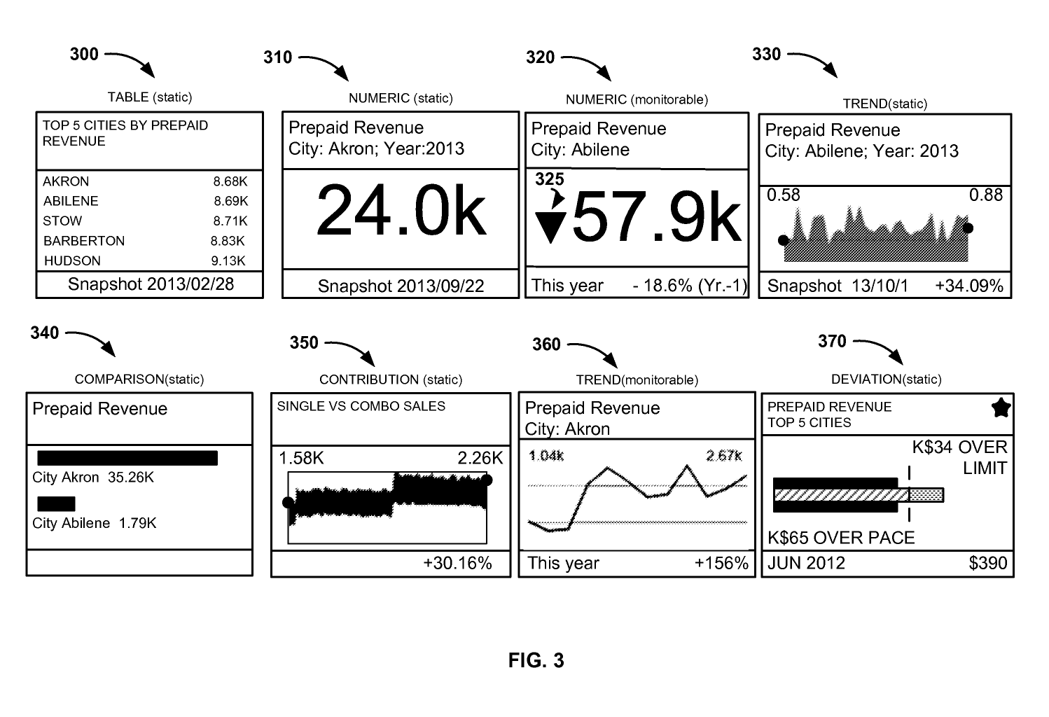

FIG. 3 is a block diagram illustrating exemplary widgets of different types, according to one embodiment. In one embodiment, key points may be visual representation of key indicators in a condensed manner that allows a user to check the static level of the key indicators or to monitor the dynamic aspects of that key indicator. In one embodiment, widgets may be divided according to their type—key points, alerts, videos, actions, etc. Key point widgets may be also divided into subtypes, e.g. trend, contribution, comparison, deviation, table, numeric, metrics, etc. The trend key point widgets may show one or more measures tracked over time, typically in a line chart with time on the x-axis and the measure on the y-axis. The contribution key point widget may display how a quantitative whole is divided into sub-categories, and the relative size of these sub-categories according to a measure. A pie chart, a strip chart, or other may be used to present a contribution key point widget. The comparison key point widget may isolate several dimensional values and show their relative quantities according to a measure. For example, bar charts are used to display comparison between values. The deviation key point widget may display precisely how a dimension value measure differs from one or more related measures. Examples of related measures include actual dimension value quantities versus, for example, a dimension's limit or average. The table key point widget may be used for listing dimension values and index them to a common measure or for ranking a small set of dimension values and showing their measure quantities. The numeric key point widgets may be used to show a numerical value of a measure for a given dimensional value, e.g. for a fixed point of time. The metric key point type may be a type of a numeric key point widget and may be intended to represent measures and contain large numeric displays for tracking key business measures. The mentioned examples of types of key point widgets may be generated as static widgets and/or as monitorable widgets according to user's needs and preferences and the dynamicity of the dataset. In another embodiment, widgets may be alerts that notify a user when a predefined value is exceeded or diminished. Displayed widgets 300, 310, 320, 330, 340, 350, 360, and 370 are examples of key point widget types that are generated to highlight or monitor key indicators.

The widgets 300, 310, 320, 330, 340, 350, 360, and 370 may be generated based on different display of data corresponding to a different data context. For example, they may be generated based on a bar chart that displays revenue for a set of cities for the current year. The displayed revenue for each of the cities may be divided between subcategories of a sales type—if it is a single or a combo sale type. The set of cities may be a filtered set of cities from the cities contained in raw data used for generating the bar chart. In one embodiment, a particular user may be interested in monitoring a key indicator, which is a revenue for a particular city from the set of cities displayed in the bar chart. The user may select a bar from the bar chart that corresponds to the chosen city for monitoring. The bar may be used for generating a widget of a different type. For example, the user may monitor the current amount of the revenue, or may monitor the trend of the revenue in comparison with the previous year.

Widgets 300, 310, 320, 330, 360, 370 may be used to monitor and highlight different aspects of the revenue accumulated by cities from the top five cities with highest revenue. The information about the previous year may not be displayed in the bar chart used for generating the widget, but the information is part of the data context of the displayed information in the bar chart. Therefore, a widget may be generated based on the data context of the displayed information used for defining a key indicator. Further, the user may generate a widget to monitor how the revenue is divided between the categories of the sales type—single or combo sales. The widget 350 may be used for such purpose. The widget 340 may be used for highlighting a comparison between the generated prepaid revenue in two cities of interest—Akron and Abilene. The widget 300 is an example of a key point widget of a table type that shows the five top cities with highest prepaid revenue measure on Feb. 28, 2013. The widgets 310 and 320 are examples of key point widgets of numeric type, which may be generated based on a common chart displaying revenue for a set of cities for the current year. The widget 310 is a static widget that displays information about the received revenue for city “Akron” for year 2013, which is generated by Sep. 22, 2013. Therefore, the widget 310 is generated based on static data about the revenue generated up to a defined date. On the other hand, the widget 320 is a monitorable (or dynamic) key point widget, which displays data about the received revenue for city “Abilene” for this year, which is by 18.6% smaller than the revenue received for the previous year. In the widget 320 there is an arrow 325 that shows that the revenue had decreased from previous year. In the lower right corner of the widget there is information about the percentage of the decrease. The widget 320 is monitorable, as it will change the displayed data in it when there is a change in the accumulated revenue for the city “Abilene”. A change in the raw data stored for this city will reflect on widget's content, when the widget is of monitorable type. The widget 330 and the widget 360 are key point widgets of trend type, which are static and monitorable, respectively. They provide inside into the change in the prepaid revenue for cities Abilene and Akron. If a change in the data about city Akron appears, then the widget 360, which is monitorable, will be dynamically changed. The widget 340 is an example of a comparison key point widget. The widget 350 is an example of a contribution key point widget. The widget 340 is an example of a deviation key point widget. The widgets 340, 350 and 370 are static widgets.

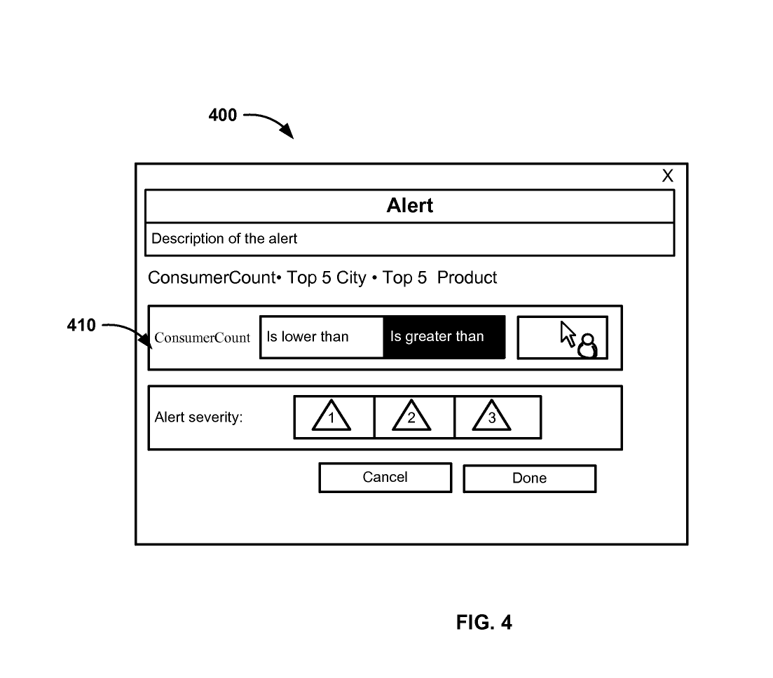

FIG. 4 is a block diagram illustrating an exemplary alert 400 created during data navigation and selection, according to one embodiment. The alert 400 may be created based on displayed data, such as the displayed data in the screen 200 in FIG. 2. The alert 400 may be created by a user to notify when a certain number of consumers had been registered for a given city, for a particular product, or other criteria. The alert 400 is a widget that is created by a selection made by a user to define the particular key indicator of interest and a selection of the type of the widget—“alert”. When building the alert, required data from the data context of the selection made by the user is extracted and monitored. The alert 400 may be configured to notify the user when certain criteria are met. The criteria may be defined within a user interface, for example, at section 410 of the alert. When the number of consumers, which is represented by the label “ConsumerCount” is greater than a user predefined number, then the user is notified. The created alert may be stored as part of a portal application for monitoring different types of widgets of interest to the user, which may be based on different data sources. For a given alert, such as the alert 400, a severity level may be defined—for example, from a scale from 1 to 3.

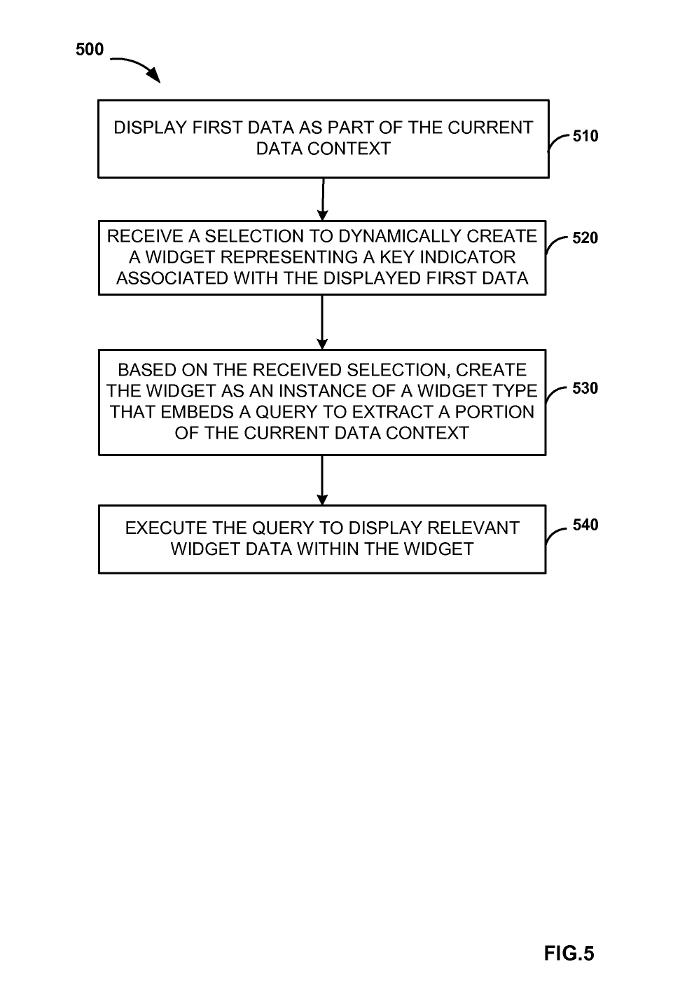

FIG. 5 is a flow diagram illustrating a process 500 for generating widgets based on a current data context. At 510, first data is displayed. The first data is part of the current data context that is used for generating the first data. The current data context includes the first data and related data to the first data. At 520, a selection is received to dynamically create a widget that represents a key indicator. The key indicator is an indicator associated with the displayed first data. For example, the key indicator may be the top five cities that have the highest number of customers of a set of products offered by a company. In one embodiment, the received selection (520) may define the key indicator and request a widget type for the widget. At 530, based on the received selection, a widget is created as an instance of a widget type. For example, the widget may be created as a widget of key point widget type. The created widget (530) may embed a query that extracts a portion of the current data context that is relevant for the defined widget. Implemented logic in the query corresponds to the made selection at the 520, the widget type, and the current context used for generating the widget. At 540, the query is executed and relevant widget data is displayed within the widget.

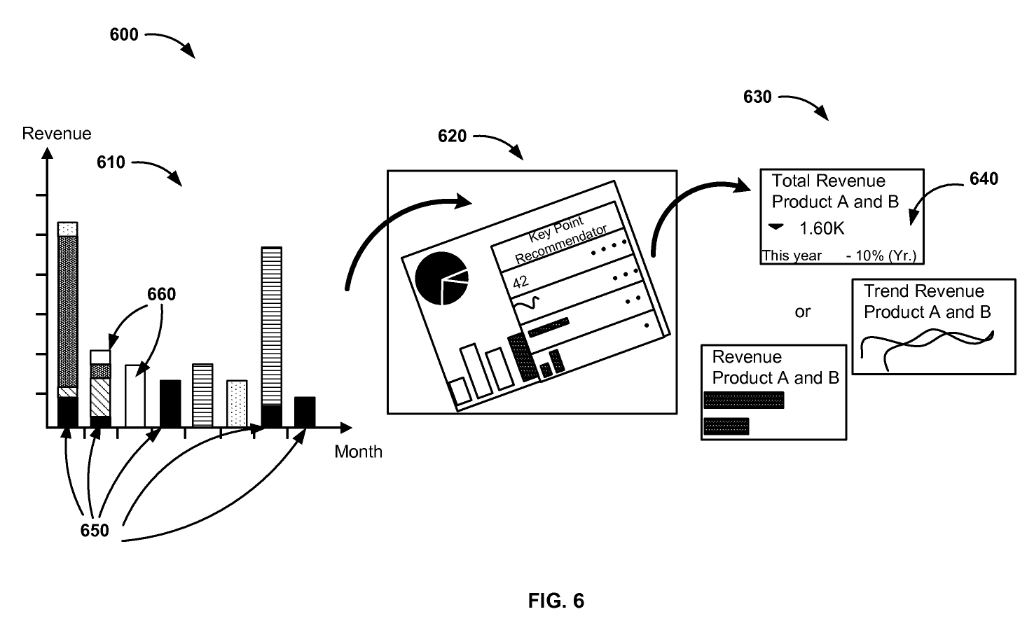

FIG. 6 is a block diagram illustrating landscape 600 where widgets could be generated based on a chart 610 generated over raw data, according to one embodiment. The chart 610 is a bar chart that includes bars representing generated sum of the revenue by a company per month for a set of products. Each bar from the chart 610 is divided into sections that correspond to the revenue generated from a product from the set of products. The chart 610 allows a user to have an overview of how the products sold by the company reflect the revenue of each month of the monitored period. The user may be interested in monitoring the revenue generated by a product A and B, which are marked with a black box (boxes 650) and a white box (boxes 650) on the bars.

In one embodiment, a selection over the black boxes 650 and the white boxes 660 may be performed to trigger creation of a widget for representing a key indicator about the revenue from products A and B. The widget may be based on the displayed data in the chart 610. Based on the made selection, a current data context of the displayed data in the chart 610 may be determined. The current data context may be a description of the context that includes information for the displayed data in the chart 610, the selection and selected data, and further includes additional contexts (such as a time context), a type of a selection, a number of selections, etc. The additional contexts may be associated with the global filters that may be applied over the data when presented to the user (e.g. chart 610). According to the determined current data context, a list of possible widget types may be defined. Such list may include different types of key point widgets, alerts, videos, actions, etc. The determined list may include only such widget types that are relevant for the current context and for the made selection. In one embodiment, the list may be a ranked list. The ranking may be based according to a predetermined logic for ranking. For example, based on user's past history, the ranked list may include those widget types that are the most used for similar selections, e.g., a user only creates numeric key point widgets, so the list ranks numeric key point widgets in the beginning of the ranked list. Based on the determined list of widget types, an advice 620 with recommended widget descriptors may be provided to the user. The advice 620 includes widget descriptors that correspond to the widget types from the list of widget types. The advice 620 may include different types of widgets, which may be monitorable and static. From the suggested advice 620, a selection of a widget descriptor may be made to create a widget as an instance of the selected widget descriptor.

In one embodiment, a list of widgets 630 may be created based on the provided advice 620. A widget from the list of widgets 630 may include a widget query to extract a portion of the current data context. The extracted portion may be further structured when presented in a given widget. For example, widget 640 is part of the list of widgets 630 created based on the data context of the presented chart 610 for monitoring the revenue gained from product A and B. The widget 640 is a monitorable widget that shows what is the revenue generated for the current year—1.60K. The revenue is less than the revenue generated by the previous year, as this is visible from the arrow pointing downwards and the −10% displayed in the lower right corner. If the time when this widget is created is two months before the end of the current year, then the value 1.60K may be changed according to the newly stored data about the revenue for the next two months. Such newly stored data is not visible in the chart 610 but it is stored, for example, at a repository that stores raw data used for generating the chart 610. The chart 610 presents data for the revenue per month. However, a widget created based on the chart 610 may apply another time granularity, as such data is extracted based on the data context of the chart 610.

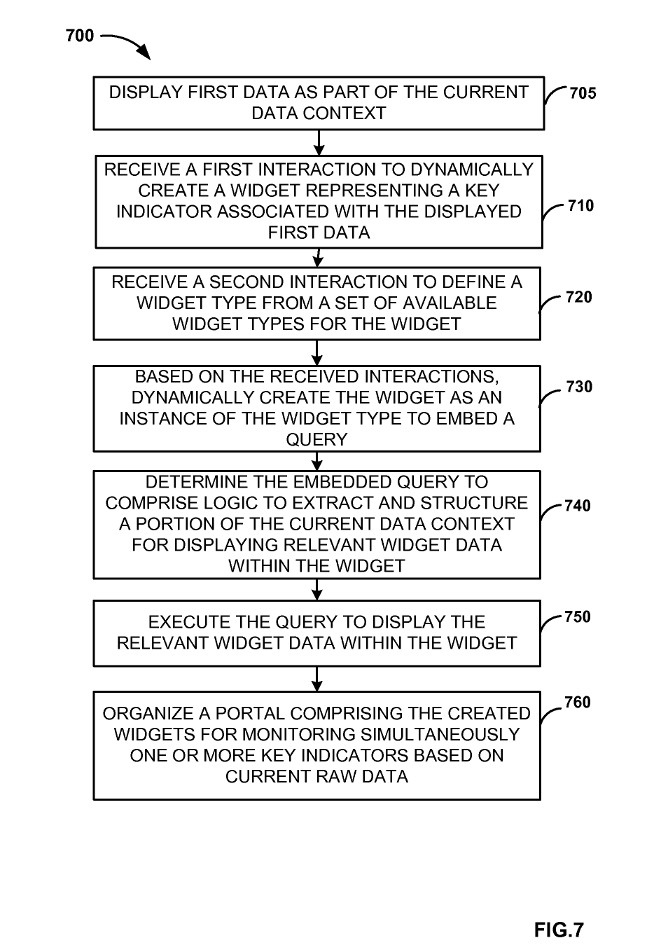

FIG. 7 is a flow diagram illustrating a process 700 for creating widgets and monitoring key indicators from a portal application, according to one embodiment. At 705, first data is displayed that is part of a current data context. At 710, a first interaction is received to create a widget for monitoring a key indicator, defined based on the first displayed data. At 720, a second interaction is received that defines a widget type for the widget from a set of predefined available options for the widget. The predefined set of available options may be generated based on determining the current data context of the first displayed data and the first interaction made at the 710. At 730, the widget is created based on the received interactions. The widget is created as an instance of the selected widget type and embeds a query for extracting required data from the current data context. At 740, the embedded query is defined to include logic to extract and structure a portion of the current data context for displaying relevant widget data within the widget. At 750, the query is executed and the relevant widget data is displayed. At 760, a portal is organized to display created widgets, including the created widget during steps 710 to 750. The portal is organized to simultaneously monitor key indicators defined based on raw data displayed in different formats to a user. In one embodiment, the key indicators may be defined based on the first displayed data (705), or by alternative display of data, aggregated based on the same raw data. In another embodiment, the portal may include widgets generated based on different sets of raw data stored at different places and repositories.

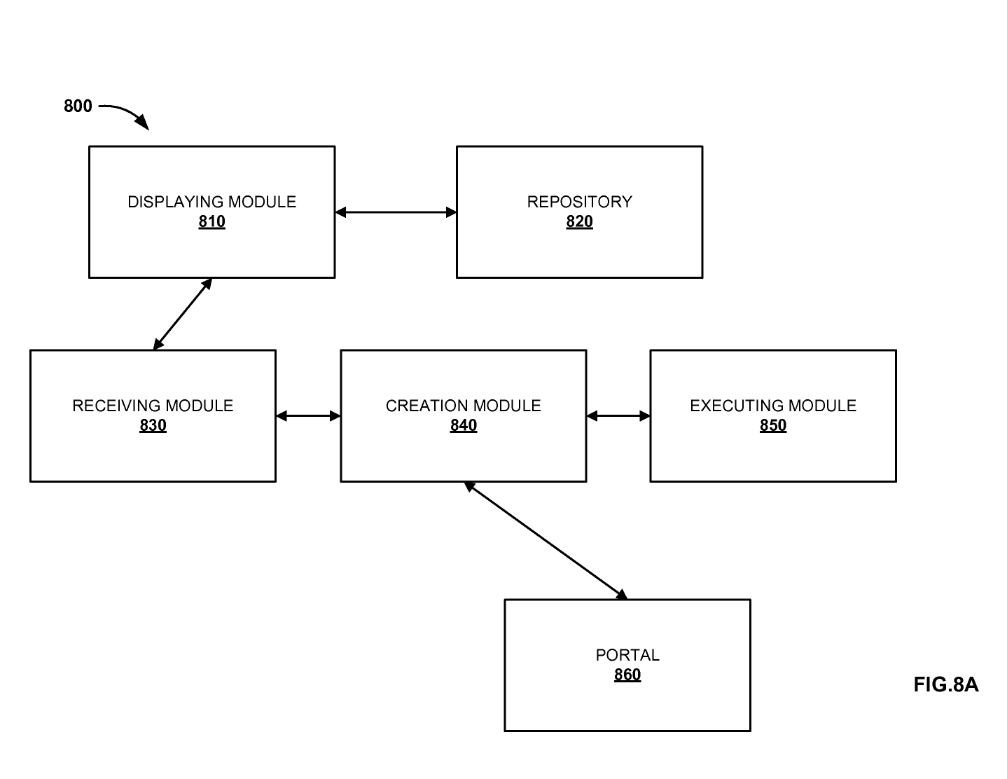

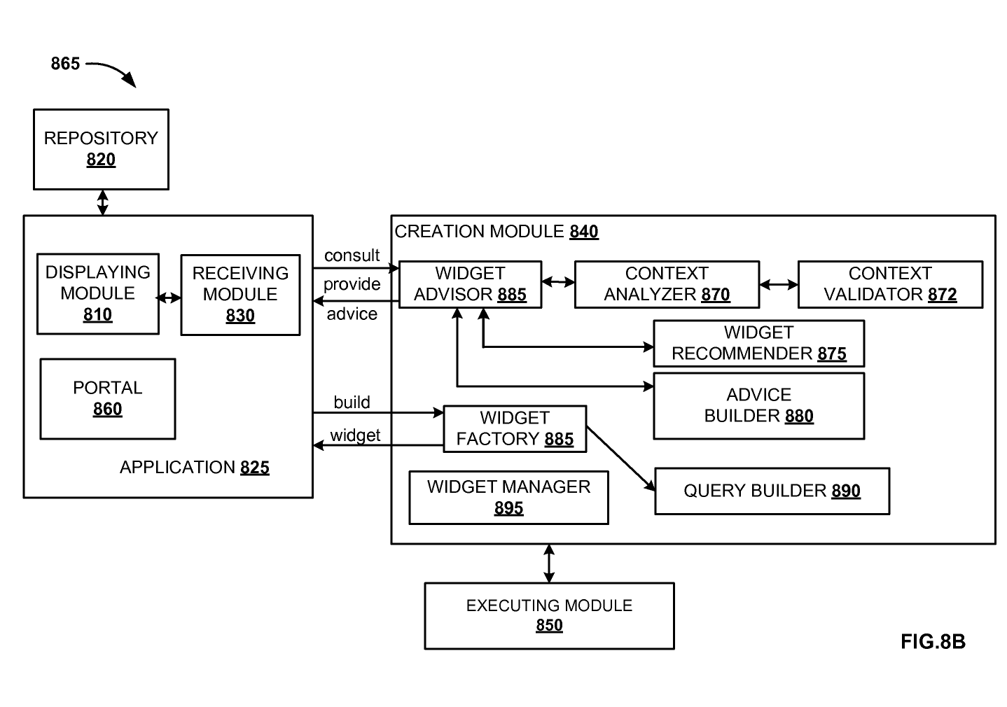

FIG. 8A is a block diagram illustrating a system 800 for creating widgets based on a current data context, according to one embodiment. A display module 810 displays data, for example, such as the displayed data in FIG. 2, the bar chart 610, FIG. 6, or other. The displaying module 810 may be connected to a repository 820 that stores raw data. The displayed data may be a result of navigation and/or aggregation of existing raw data in the repository 820. The displaying module 810 may display the data in a GUI part of an application, such as a business intelligence (BI) application. The displaying module 810 is in communication with a receiving module 830. The receiving module 830 receives a first interaction to create a widget representing a key indicator. The key indicator is associated with the data displayed by the displaying module 810. The key indicator may be such as the discussed examples in FIG. 2, FIG. 3, and FIG. 6. The first interaction may be a selection over a part of the displayed data on the displaying module 810. The receiving module 830 is further operable to receive a second interaction defining a widget type for the widget from a set of predefined and offered list of widget types. The offered list of widgets types may be presented through the displaying module 810 to the user. The interactions received by the receiving module 830 may be user interactions performed with the use of a mouse, keyboard, touch screen, etc. The receiving module 830 is in communication with a creation module 840. The creation module 840 creates the widget based on the received interactions with the receiving module 830. The created widget is an instance of the selected widget type and embeds a query that may be executed against the data stored in the repository 820. The creation module 840 may be further operable to determine a current data context for creating the widget based on the displayed data on the displaying module 810 and the received interactions to define the key indicator for the widget. For example, the displayed data and the current data context may be such as the discussed displayed data in the chart 610 and current data context in FIG. 6. The determined current data context may be used for generating a list of offered widgets types for the key indicator. The creation module 840 embeds a query in the widget that comprises logic to extract and structure a portion of the current data context to be displayed within the widget. The creation module 840 is connected to an executing module 850 that executes the embedded query to display relevant widget data within the widget. The creation module 840 is also connected to a portal 860 application that includes created widgets for simultaneous monitoring of key indicators. The creation module 840 may send the created widget to the portal 860 to be monitored. The portal 860 may include widgets created for key indicators from displayed data generated based on the raw data stored in the repository 820. In another embodiment, the portal 860 may further store widgets created based on displayed data generated based on different raw data than the data stored in repository 820.

FIG. 8B is a block diagram illustrating a system 865 for creating widgets based on a current data context, according to one embodiment. Repository 820, displaying module 810, receiving module 830, portal 860, creation module 840, and execution module 850 corresponds to the repository 820, the displaying module 810, the receiving module 830, the portal 860, the creation module 840, and the execution module 850 in FIG. 8A. An application 825 includes the displaying module 810, the receiving module 830, and the portal 860. The application 825 may be a BI application that communicates with the repository 820 and provides a user with tools and techniques to present different views and charts generated based on raw data stored in the repository 820. The displaying module 810 presents data to a user for generating a widget. The receiving module 830 receives an interaction of a selection of a part of the presented data, defining a key indicator for monitoring from the widget. The application 825 consults with a widget advisor 885 to generate an advice including a list of widget descriptors that may be created from a current context determined for the widget. The list of widget descriptors may include descriptors of key points, alerts, videos, etc. The widget advisor 885 checks with a context analyzer 870 that the presented data by the displaying module 810 is valid. The context analyzer 870 communicates with a context validator 872 to determine if the presented data is valid. If the presented data is valid, the context analyzer 870 returns a description of a current data context. The context analyzer 870 analyzes the presented data and determines a time context if any. For example, the context analyzer 870 extracts a time hierarchy from a data source stored in the repository 820 and looks for time dimensions in existing filters, selections, etc., relevant to the presented data by the displaying module 810. The context analyzer 870 may further analyze if the selection received by the receiving module 830 is a mono or a multi selection. The context analyzer 870 may further analyze the measures and dimensions of the presented data by the displaying module 810. The context analyzer 870 may build a context descriptor of the current data context that includes a time context, type of selections made, the number of measures and dimensions for the presented data.

The widget advisor 885 may communicate with a widget recommender 875 to provide a list of widget types relevant for the current data context. The provided list of widget types may be a ranked list of widget types according to relevance to the current data context, the key indicator, the made selection, etc. Based on the number of measures and dimensions in the presented data, the number of selections received by the receiving module 830, the determined current data context including the time context, different widget types may be of greater relevance. For example, based on the number of values displayed in the selection, an appropriate key point widget type may be recommended.

The widget advisor 885 may communicate with an advice builder 880 to generate the advice including a list of widget descriptors that correspond to the determined list of widget types generated by the widget recommender 875. To generate the advice, the advice builder 880 may take information about the presented data, the current data context, and the list of widget types. A widget descriptor from the advice may contain a widget type, a Boolean value defining if the widget is monitorable or static, a Boolean value defining if the widget presents calculated data, a description of the current data context, etc. For example, the widget may present calculated data when there is a multi-selection over the displayed data (e.g. for year 2012 and year 2013), and the widget may perform an aggregation of the made selection rather than generating separate widgets (e.g. one for year 2012 and another one for year 2013). The widget descriptor may further contain configuration properties, if the widget is a monitorable one. In one embodiment, for each widget descriptor of a monitorable widget, there may be a default configuration. In another embodiment, a user may define more specific configuration for the monitorable widget through a user interface. The configuration properties may include a period for monitoring, a granularity for monitoring, a desired trend direction, a comparison period, etc. A user may define which period of time to monitor, e.g. current year, day, week, month, quarter. Further, for the granularity for monitoring, a user may define a time period for monitoring the changes of values of a given measure. The user may choose from a list of available time dimension. For example, a user may want to monitor the time period of the current year, and see the trend of changes with respect to each month, or each quarter. The desired trend direction may declare what movement of a measure is good (desired), and respectively, the opposite movement is bad. For example, the desired trend direction for the rate of unemployment is down. The comparison period may be defined for defining a direction of an arrow displayed next to a measure monitored by a widget. For example, the arrow may be such as the arrow 325 in FIG. 3. The comparison period defines a time dimension to be used for calculating a comparative change with a previous period. If the comparison period is selected to be a month, then the arrow direction will be determined based on a value calculated by comparing the current value with a value for the previous month.

The application 825 may communicate with a widget factory 885 part of the creation module to build a widget based on the provided advice with the list of widget descriptors. The receiving module 830 may receive a selection of a widget descriptor from the advice for generating a particular widget. The widget factory 885 may build the particular widget by firstly building a title for the widget based on the measures used for creating the widget. The measures are associated with the key indicator defined for the widget. A subtitle may be defined based on filters existing for the presented data by the displaying module 810. The widget factory 885 may call a query builder 890 to build a widget query. The widget factory 885 may instantiate the widget by passing information about the widget type, if the widget is monitorable or static, the widget title, the widget subtitle, configuration for the widget if the widget is monitorable, and query and time information. The creation module 840 may further include a widget manager 895, where the widget may be registered. The widget manager 895 may be responsible for the lifecycle of the widget—stopping, starting, resuming, saving, restoring, deleting, etc. of the widget. A query embedded into a monitorable widget may be run (e.g. by the execution module 850) when a change in the raw data for generating the displayed data used for creating the widget appears. Alternatively, the query embedded into the monitorable widget may be run on a regular basis. In one embodiment, the creation module 840 and the executing module 850 may be part of the application 825.

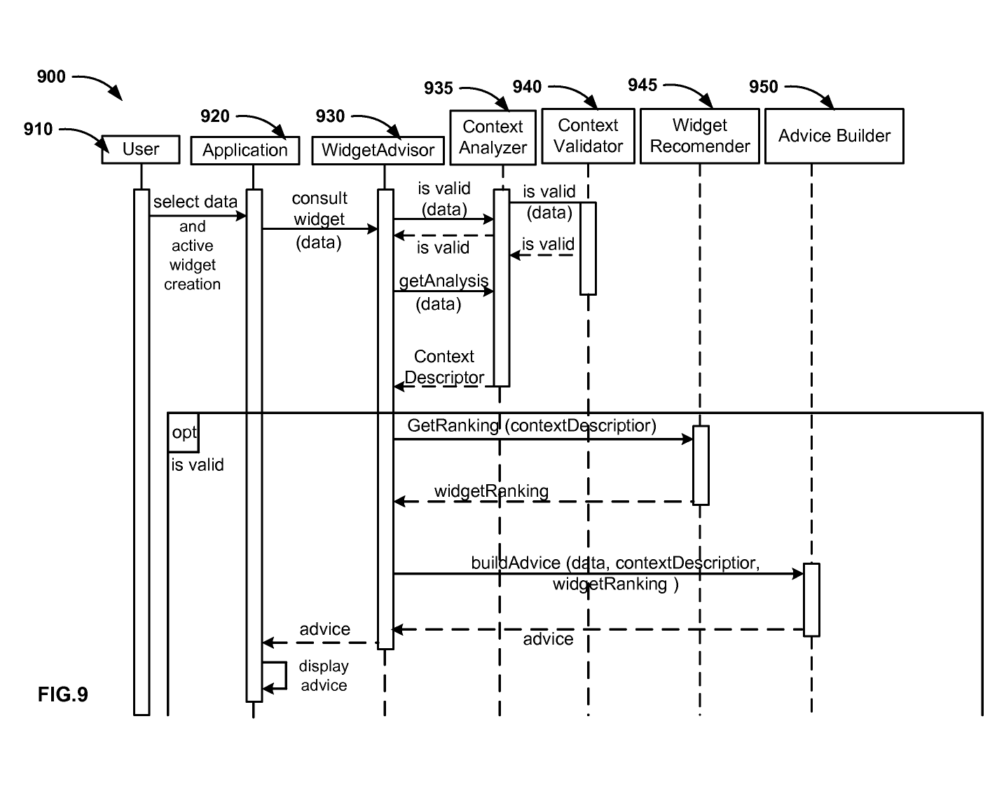

FIG. 9 is a block diagram illustrating a sequence diagram 900 for building an advice recommending a set of widget descriptors for creation of a widget, according to one embodiment. A user 910 may select data, for example, from displayed data, in form of a chart or another graphical representation. The data may be displayed in a UI of an application 920. The made selection by the user 910 may be a selection over UI elements related to the content of the chart, for example a legend or facets. The selection made by the user 910 may activate a process of widget creation. The application 920 may consult with a widget advisor 930, such as the widget advisor 885 in FIG. 8B. The widget advisor 930 may check, with a context analyzer 935, if the data is valid by calling an “isValid( )” method provided by a context validator 940. The widget advisor 930 may call a “getAnalysis( )” method provided by the context analyzer 935 with information about the presented data to the user 910 and the made selection of data. The “getAnalysis( )” method may return a description of a current context of the displayed data. After receiving the description of the current data context that is about to be used for creating the widget, the widget advisor 930 may call a “getRanking( )” method provided by a widget recommender 945 with information about the received description of the current data context. The “getRanking( )” method may return to the widget advisor 930 a ranked list of widget types relevant for the creation of the widget. The widget advisor 930 may call a “buildAdvice( )” method provided from an advice builder 950 with information about the displayed data, the current data context, and the ranked list of widget types. The “buildAdvice( )” method may return an advice to the widget advisor 930, which includes a list of widget descriptors. The list of widget descriptors are defined based on the ranked list of widget types. The suggested context analyzer 935, context validator 940, widget recommender 945, and advice builder 950 may correspond to the described context analyzer 870, context validator 872, widget recommender 875, and advice builder 880 in FIG. 8B. The widget advisor 930 may provide the received advice to the application 920 and make the advice visible to the user 910.

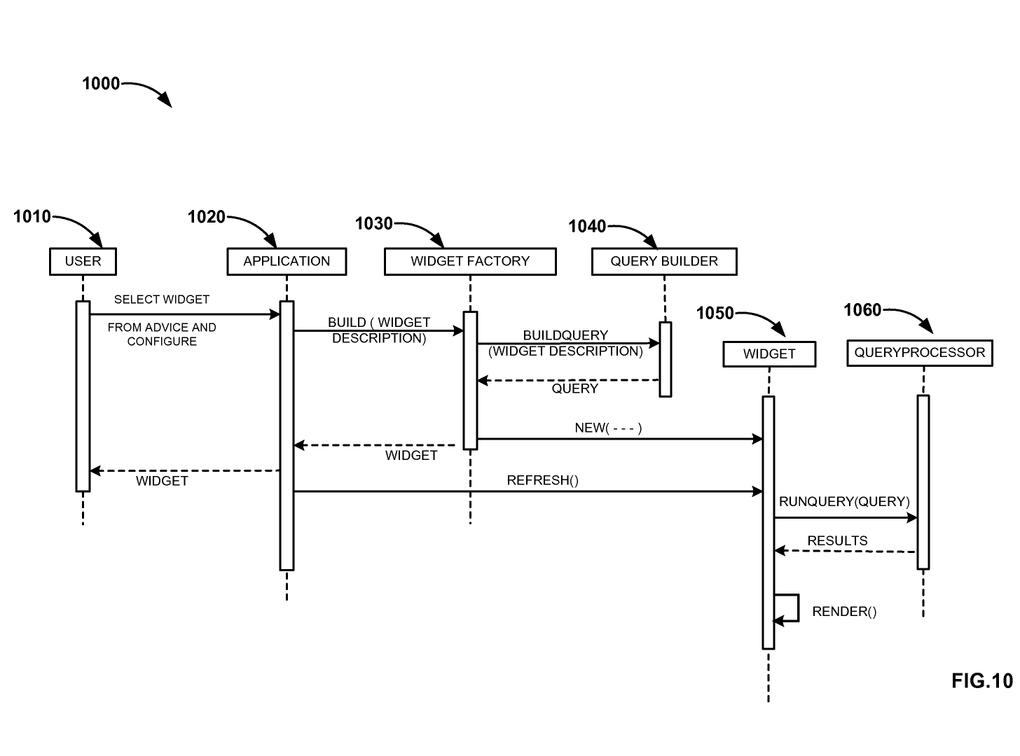

FIG. 10 is a block diagram illustrating a sequence diagram 1000 for creating a widget based on a selection from a provided advice with a recommended list of widget descriptors, according to one embodiment. An application 1200, such as the application 920 may display to a user 1010, such as the user 910, an advice including a list of widget descriptors available for creating a widget for monitoring or highlighting a key indicator. The creation of the widget may be initiated by the user 1010. The user 1010 may select a widget descriptor from the advice, which may be provided in a GUI of the application 920. The application 1020 may call a “build( )” method provided by a widget factory 1030 to build a widget as an instance of the selected widget descriptor. The widget factory 1030 may call a “buildQuery( )” method provided by a query builder 1040 to generate a query to be embedded in the created widget. The query builder 1040 is responsible for creating queries. The “buildQuery( )” method is called by the widget factory 1030 before creating the widget. The resulting query is passed to the newly created widget so that the widget owns its own query. A query may be composed of sub queries. There may be a main query to display key values for the key indicator and additional queries for monitorable widgets. For example, the additional queries may compare the main values displayed in the widget with some values from a past time period in order to define the arrows direction (such as the arrow 325, FIG. 3), displayed in a numeric key point widget and the change. A query processor 1060 is responsible for executing the queries. The query processor 1060 gets a query from a widget 1050 component, transforms it into an appropriate query language (e.g. Structural Query Language (SQL)), executes the query on a database engine and returns results. Refresh of a created widget may be initiated by the application 1020. A widget that needs to be refreshed contacts the query processor 1060 to run the embedded query and to receive results. The widget 1050 component renders the results that are received.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

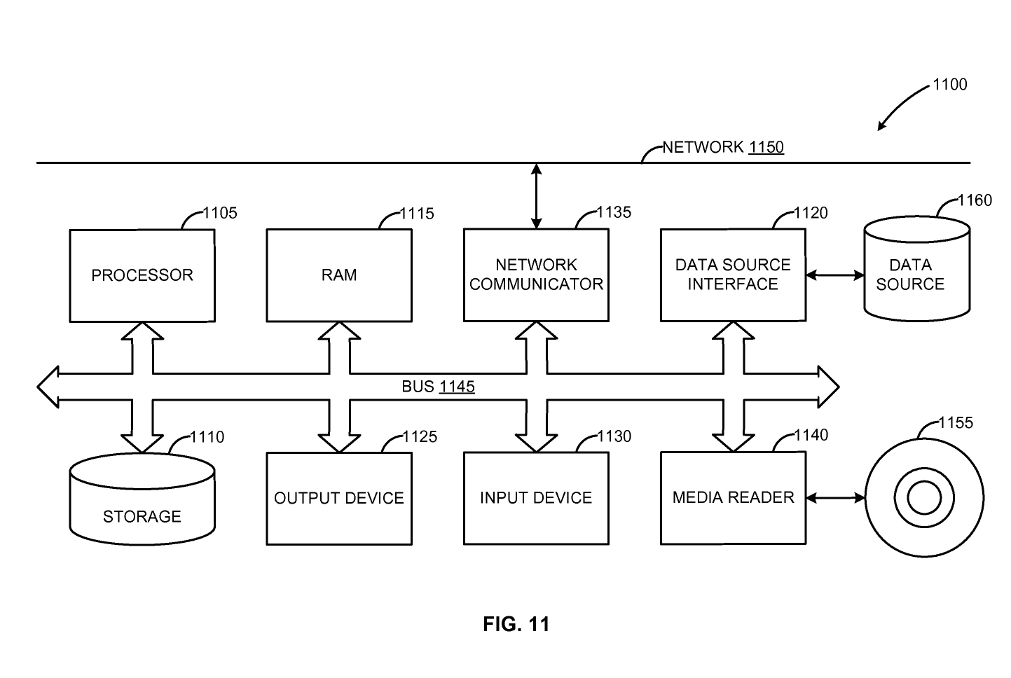

FIG. 11 is a block diagram of an exemplary computer system 1100. The computer system 1100 includes a processor 1105 that executes software instructions or code stored on a computer readable storage medium 1155 to perform the above-illustrated methods. The processor 1105 can include a plurality of cores. The computer system 1100 includes a media reader 1140 to read the instructions from the computer readable storage medium 1155 and store the instructions in storage 1110 or in random access memory (RAM) 1115. The storage 1110 provides a large space for keeping static data where at least some instructions could be stored for later execution. According to some embodiments, such as some in-memory computing system embodiments, the RAM 1115 can have sufficient storage capacity to store much of the data required for processing in the RAM 1115 instead of in the storage 1110. In some embodiments, data required for processing may be stored in the RAM 1115. The stored instructions may be further compiled to generate other representations of the instructions and dynamically stored in the RAM 1115. The processor 1105 reads instructions from the RAM 1115 and performs actions as instructed. According to one embodiment, the computer system 1100 further includes an output device 1125 (e.g., a display) to provide at least some of the results of the execution as output including, but not limited to, visual information to users and an input device 1130 to provide a user or another device with means for entering data and/or otherwise interact with the computer system 1100. Each of these output devices 1125 and input devices 1130 could be joined by one or more additional peripherals to further expand the capabilities of the computer system 1100. A network communicator 1135 may be provided to connect the computer system 1100 to a network 1150 and in turn to other devices connected to the network 1150 including other clients, servers, data stores, and interfaces, for instance. The modules of the computer system 1100 are interconnected via a bus 1145. Computer system 1100 includes a data source interface 1120 to access data source 1160. The data source 1160 can be accessed via one or more abstraction layers implemented in hardware or software. For example, the data source 1160 may be accessed by network 1150. In some embodiments the data source 1160 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method for creating widgets based on a current data context, the method comprising:
displaying first data as part of the current data context;
receiving a first interaction to dynamically create a widget representing a key indicator associated with the displayed first data;
a processor, based on the received interaction, creating the widget as an instance of a widget type that embeds a query to extract a portion of the current data context; and
executing the query to display relevant widget data within the widget.

2. The method of claim 1, wherein the first interaction comprises a selection of a part of the first data for defining the key indicator, monitored by the created widget.

3. The method of claim 1, wherein the current data context comprises the first data and related data to the first data, and wherein the related data is determined based on the first interaction and the first data.

4. The method of claim 1, wherein the relevant widget data is determined based on the key indicator, the current data context, and the widget type.

5. The method of claim 1, wherein creating the widget further comprises determining one or more available widget types for the widget depending on the received first interaction and one or more available elements from the displayed first data for monitoring the key indicator.

6. The method of claim 1, wherein creating the widget further comprises:
determining the current data context for the first data;
receiving a second interaction to select the widget type for the widget; and
based on the selected widget type, determining the embedded query to comprise logic to extract and structure the portion of the current data context for displaying the relevant widget data within the widget.

7. The method of claim 6, wherein executing the query further comprises extracting the portion of the current data context and transforming the extracted portion to be presented as relevant widget data for monitoring the key indicator within the widget.

8. The method of claim 1, wherein the widget type is selected from a group consisting of a key point, an alert, an action, and a video.

9. The method of claim 8, wherein creating the widget further comprises:
receiving a third interaction to define the key point as the widget type for creating the widget; and
receiving a fourth interaction to define a key point type for the widget type of the widget from a set of available predefined options based on amount of information from the current data context associated with representing the key indicator.

10. The method of claim 1, further comprising:
organizing a portal for widgets comprising the created widget; and
automatically updating the displayed relevant widget data within the widget when data from the current data context is updated.

11. A computer system for creating widgets based on a current data context, comprising:
a processor;
a memory in association with the processor storing instructions, which when executed by the processor generates modules comprising:
a displaying module to display first data as part of the current data context;
a receiving module to:
receive a first interaction to dynamically create a widget representing a key indicator associated with the displayed first data; and
receive a second interaction to define a widget type from a set of available widget types for the widget;
a creation module, based on the received interactions from the receiving module, to:
determine the current data context for the first data;
dynamically create the widget as an instance of the widget type to embed a query; and
determine the embedded query to comprise logic to extract and structure a portion of the current data context for displaying relevant widget data within the widget;
executing module to execute the query to display the relevant widget data within the widget; and
a portal comprising the created widgets to simultaneously monitor one or more key indicators based on current raw data; and
a repository to store current raw data, wherein the displayed first data is based on the current raw data.

12. The system of claim 11, wherein the first interaction comprises a selection of a part of the first data for defining the key indicator, monitored by the created widget.

13. The system of claim 11, wherein the creation module is further operable to:
determine the current data context for the first data; and
determine the set of available widget types for the widget depending on the received first interaction and one or more available elements from the displayed first data for monitoring the key indicator.

14. The system of claim 12, wherein the displaying module is further operable to display the set of available widget types as a sorted list of options according to widget type relevance, wherein relevance is determined based on the current data context, the first data, and the received first interaction.

15. The system of claim 10, wherein the executing module is further operable to extract the portion of the current data context and transform the extracted portion to be presented as relevant widget data for monitoring the key indicator within the widget.

16. The system of claim 10, wherein the memory further stores instructions related to:
a widget manager to manage a lifecycle of the widget, wherein the widget manager runs the embedded query when stored current raw data, aggregated for generating the displayed first data, is changed.

17. An article of manufacture for creating widgets based on a current data context, comprising a non-transitory computer-readable medium storing instructions, which when executed, cause a computer system to:
display first data;
receive a first selection over the first data to dynamically build a widget representing a key indicator associated with the displayed first data;
determine the current data context of the first displayed data;
based on the determined current data context, define a list of widget types relevant for the current data context for building the widget;
provide an advice comprising a list of widget descriptors corresponding to the list of widget types;
based on a second selection, build the widget as an instance of a selected widget descriptor that embeds a widget query to extract a portion of the current data context; and
execute the widget query to display relevant widget data within the widget.

18. The article of manufacture of claim 17, wherein a widget descriptor from the list of widget descriptors is configured to define properties comprising a period for monitoring, a granularity of monitoring, a desired trend direction, and a comparison period.

19. The article of manufacture of claim 17, wherein the defined list of widget types is a ranked list of widget types sorted by relevance.

20. The article of manufacture of claim 17, further comprising:
register the widget to a widget manager for managing a lifecycle of the widget, wherein the widget manager runs the embedded widget query when raw data, aggregated for generating the displayed first data, is changed.
